(19) United States
(12) Patent Application Publication
(10) Pub. No.: US 2024/0067411 A1
(43) Pub. Date: Feb. 29, 2024

(54) STORAGE BAG FOR AGRICULTURAL PRODUCTS

(71) Applicant: Berry Global, Inc., Evansville, IN (US)

(72) Inventors: Xiaojiang Zhang, Evansville, IN (US); Michael A. Kinnan, North Canton, OH (US)

(21) Appl. No.: 18/240,053

(22) Filed: Aug. 30, 2023

Related U.S. Application Data
(60) Provisional application No. 63/402,762, filed on Aug. 31, 2022.

(51) Int. Cl. B65D 35/08; B65D 65/38; C08J 5/18

(52) U.S. Cl. CPC B65D 35/08; B65D 65/38; C08J 5/18; C08J 2323/06

(57) ABSTRACT

A storage bag for storing agricultural products comprising a polymeric tube formed to include a storage space therein and a fill aperture arranged to open into the storage space at a first end of the polymeric tube. The polymeric tube is formed from a film.

### PRIORITY CLAIM

This application claims priority under 35 U.S.C. § 119(e) to U.S. Provisional Application Ser. No. 63/402,762, filed Aug. 31, 2022, which is expressly incorporated by reference herein.

### BACKGROUND

The present disclosure relates to bags, and particularly to storage bags. More particularly, the present disclosure relates to storage bags for agricultural products.

### SUMMARY

According to the present disclosure, a multilayer film is used to form a storage bag for storing agricultural products. The storage bag includes a polymeric tube formed to include a storage space and a fill aperture arranged to open into the storage space at a first end. A first closure is coupled to an opposite second end of the polymeric tube to close the second end.

In an illustrative embodiment, the multilayer film is configured to minimize circumferential creep in the polymeric tube during filling of the storage bag with agricultural products and to minimize puncture and tearing of the storage bag so that amounts of agricultural products stored in the storage space are maximized.

In another illustrative embodiment, the polymeric tube is formed from a multilayer film comprising an inner layer configured to define, at least in part, the storage space, an outer layer located in spaced-apart relation to the inner layer, and a core layer located between the inner and outer layers.

In another illustrative embodiment, the multilayer film includes an inner layer, an outer layer spaced apart from the inner layer, and a core layer arranged to extend between and interconnect the inner layer and the outer layer. The inner layer may include a polyethylene polymer. The outer layer may include a polyethylene polymer. At least one of the layers of the multilayer film is configured to minimize puncture of the multilayer film by objects extending through the multilayer film from the inner layer through the outer layer so that puncture and tearing of the multilayer film is minimized.

In another illustrative embodiment, at least one of the layers of the multilayer film is configured to minimize circumferential creep in the polymeric tube during filling of the storage bag by agricultural products so that puncture and tearing of the storage bag is minimized.

In another illustrative embodiment, at least one of the layers of the multilayer film comprises a polyethylene polymer and a polyethylene-incompatible polymer. For example, the polyethylene-incompatible polymer may be polystyrene.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a storage bag made from a multilayer film in accordance with the present disclosure and showing that the storage bag includes an interior storage space configured to receive agricultural products;

FIG. 2 is a diagrammatic view of the multilayer film use to form the storage bag of FIG. 1 showing that the multilayer film includes from top to bottom, an outer layer, a first core layer, a second core layer, a third core layer, a fourth core layer, a fifth core layer, and an inner layer;

FIG. 3 is a sectional view taken along line 3-3 of the storage bag of FIG. 1;

FIG. 4 is an enlarged view of a portion of FIG. 3 showing that portions of the storage bag experience circumferential stretching during filling and use of the storage bag;

FIG. 5 is a micrograph of the cross-section of multilayer film 1A; and

FIG. 6 is a Raman spectrum of six layers found in 7-layer of multilayer film 1A with the arrows indicating the incorporation of polystyrene in layers 31 and 35.

### DETAILED DESCRIPTION

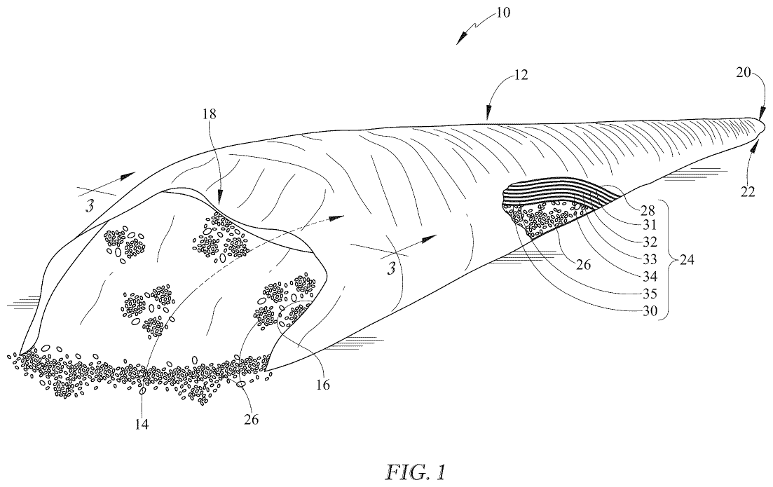

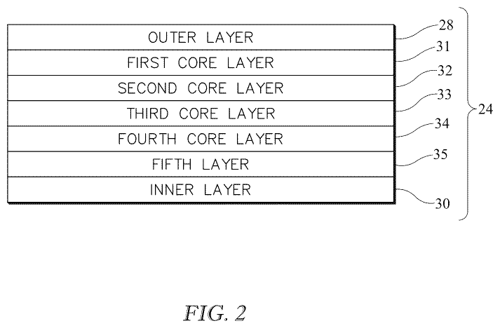

A storage bag 10 in accordance with a first example of the present disclosure is shown in FIG. 1. The storage bag 10 may be used to stored agricultural products therein. The storage bag 10 includes a polymeric tube 12 formed to include a storage space 14 and a fill aperture 16 arranged to open into the storage space 14 at a first end 18 of the tube as shown in FIG. 1. A first closure 20 is coupled to an opposite second end 22 of the polymeric tube 12 to close the second end 22. The storage bag 10 is made, for example, from a multilayer film 24 as shown in FIGS. 1 and 2. The multilayer film 24 is configured to minimize circumferential creep in the polymeric tube 12 during filling of the storage bag 10 with agricultural products 26 and to minimize puncture and tearing of the storage bag 10 so that amounts of agricultural products 26 stored in the storage space 10 are maximized.

In one example, the agricultural products 26 may comprise crops. In another example, the agricultural products 26 may comprise grass, corn, maise, oats, silage, haylage, or any other suitable product. In another example, the agricultural products 26 may be stored in the storage bag 10 for a period of time. In another example, the agricultural products 26 may be stored in the storage bag 10 for a period of time to undergo the process of fermentation.

The multilayer film 24 comprises, in order from outer to inner, an outer layer 28, a first core layer 31, a second core layer 32, a third core layer 33, a fourth core layer 34, a fifth core layer 35, and an inner layer 30 as shown in FIGS. 1 and 2. The multilayer film 24 is configured to minimize circumferential creep in the polymeric tube 12 during filling of the storage bag 10 in the storage space 14 adapted to receive and store agricultural products 26 so that puncture and tearing of the storage bag 10 is minimized.

In one example, the polymeric tube 12 has a length of about 350 feet. In another example, the polymeric tube 12 has a length of about 500 feet. The polymeric tube 12 may be one of several different lengths or fall within one of several different ranges. The length of the polymeric tube 12 may be one of the following values: about 200 feet, about 250 feet, about 300 feet, about 350 feet, about 400 feet, about 450 feet, about 550 feet, about 600 feet, about 650 feet, about 700 feet, and about 750 feet. It is within the present disclosure for has a length of the polymeric tube 12 to fall within one of the following ranges: greater than about 200 feet, less than about 750 feet, about 200 feet to about 750 feet, greater than about 300 feet, less than about 600 feet, about 300 feet to about 600 feet, about 200 feet to about 600 feet, about 300 feet to about 750 feet, and about 350 feet to about 500 feet.

In one example, the polymeric tube 12 has a diameter dimension of about 10 feet. In another example, the polymeric tube 12 has a diameter dimension of about 12 feet. The polymeric tube 12 may be one of several different diameters or fall within one of several different ranges. The diameter of the polymeric tube 12 may be one of the following values: about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, and about 20 feet. It is within the present disclosure for the diameter dimension of the polymeric tube 12 to fall within one of the following ranges: greater than about 5 feet, about 5 feet to about 20 feet, greater than about 10 feet, about 5 feet to about 15 feet, about 10 feet to about 20 feet, and about 10 feet to about 15 feet. It is within the present disclosure for the preferred diameter dimension of the polymeric tube 12 to fall within one of the following ranges: about 6 feet to about 14 feet, about 7 feet to about 14 feet, about 6 feet to about 11 feet, and about 7 feet to about 11 feet.

In one example, the polymeric tube 12 has a particular length and a diameter. In a few examples, the polymeric tube 12 may have a length of about 200 feet and a diameter of about 8 feet, a length of about 200 feet and a diameter of about 9 feet, a length of about 200 feet and a diameter of about 10 feet, a length of about 200 feet and a diameter of about 11 feet, a length of about 200 feet and a diameter of about 12 feet, a length of about 200 feet and a diameter of about 13 feet, a length of about 200 feet and a diameter of about 14 feet, a length of about 200 feet and a diameter of about 15 feet, about 250 feet and a diameter of about 8 feet, a length of about 250 feet and a diameter of about 9 feet, a length of about 250 feet and a diameter of about 10 feet, a length of about 250 feet and a diameter of about 11 feet, a length of about 250 feet and a diameter of about 12 feet, a length of about 250 feet and a diameter of about 13 feet, a length of about 250 feet and a diameter of about 14 feet, a length of about 250 feet and a diameter of about 15 feet, about 300 feet and a diameter of about 8 feet, a length of about 300 feet and a diameter of about 9 feet, a length of about 300 feet and a diameter of about 10 feet, a length of about 300 feet and a diameter of about 11 feet, a length of about 300 feet and a diameter of about 12 feet, a length of about 300 feet and a diameter of about 13 feet, a length of about 300 feet and a diameter of about 14 feet, a length of about 300 feet and a diameter of about 15 feet, about 350 feet and a diameter of about 8 feet, a length of about 350 feet and a diameter of about 9 feet, a length of about 350 feet and a diameter of about 10 feet, a length of about 350 feet and a diameter of about 11 feet, a length of about 350 feet and a diameter of about 12 feet, a length of about 350 feet and a diameter of about 13 feet, a length of about 350 feet and a diameter of about 14 feet, a length of about 350 feet and a diameter of about 15 feet, about 400 feet and a diameter of about 8 feet, a length of about 400 feet and a diameter of about 9 feet, a length of about 400 feet and a diameter of about 10 feet, a length of about 400 feet and a diameter of about 11 feet, a length of about 400 feet and a diameter of about 12 feet, a length of about 400 feet and a diameter of about 13 feet, a length of about 400 feet and a diameter of about 14 feet, a length of about 400 feet and a diameter of about 15 feet, about 450 feet and a diameter of about 8 feet, a length of about 450 feet and a diameter of about 9 feet, a length of about 450 feet and a diameter of about 10 feet, a length of about 450 feet and a diameter of about 11 feet, a length of about 450 feet and a diameter of about 12 feet, a length of about 450 feet and a diameter of about 13 feet, a length of about 450 feet and a diameter of about 14 feet, a length of about 450 feet and a diameter of about 15 feet, about 500 feet and a diameter of about 8 feet, a length of about 500 feet and a diameter of about 9 feet, a length of about 500 feet and a diameter of about 10 feet, a length of about 500 feet and a diameter of about 11 feet, a length of about 500 feet and a diameter of about 12 feet, a length of about 500 feet and a diameter of about 13 feet, a length of about 500 feet and a diameter of about 14 feet, a length of about 500 feet and a diameter of about 15 feet, about 600 feet and a diameter of about 8 feet, a length of about 600 feet and a diameter of about 9 feet, a length of about 600 feet and a diameter of about 10 feet, a length of about 600 feet and a diameter of about 11 feet, a length of about 600 feet and a diameter of about 12 feet, a length of about 600 feet and a diameter of about 13 feet, a length of about 600 feet and a diameter of about 14 feet, a length of about 600 feet and a diameter of about 15 feet, about 750 feet and a diameter of about 8 feet, a length of about 750 feet and a diameter of about 9 feet, a length of about 750 feet and a diameter of about 10 feet, a length of about 750 feet and a diameter of about 11 feet, a length of about 750 feet and a diameter of about 12 feet, a length of about 750 feet and a diameter of about 13 feet, a length of about 750 feet and a diameter of about 14 feet, and a length of about 750 feet and a diameter of about 15 feet.

In one example, the polymeric tube 12 comprises a weight. The weight of the polymeric tube 12 may be dependent upon the dimensions of the polymeric tube 12. The weight of the polymeric tube 12 may fall within one of several different ranges. It is within the present disclosure for the weight of the polymeric tube 12 to fall within one of the following weight ranges: less than about 1000 lbs, less than about 900 lbs, and about 100 lbs to about 1000 lbs. In one example, the weight of the polymeric tube 12 with a length of 200 feet may fall within one of several different ranges: about 100 lbs to about 400 lbs, about 100 lbs to about 300 lbs, and about 200 lbs to about 300 lbs. In another example, the weight of the polymeric tube 12 with a length of 250 feet may fall within one of several different ranges: about 200 lbs to about 500 lbs, about 200 lbs to about 400 lbs, about 300 lbs to about 500 lbs, and about 300 lbs to about 400 lbs. In another example, the weight of the polymeric tube 12 with a length of 300 feet may fall within one of several different ranges: about 300 lbs to about 600 lbs, about 300 lbs to about 550 lbs, about 350 lbs to about 600 lbs, and about 350 lbs to about 550 lbs. In another example, the weight of the polymeric tube 12 with a length of 500 feet may fall within one of several different ranges: about 600 lbs to about 1000 lbs, about 650 lbs to about 1000 lbs, about 600 lbs to about 900 lbs, and about 650 lbs to about 900 lbs.

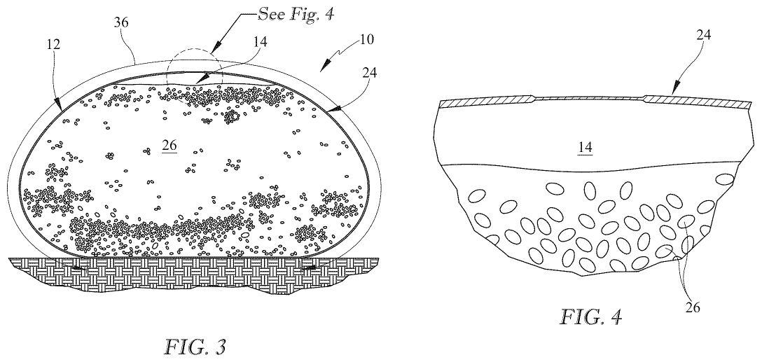

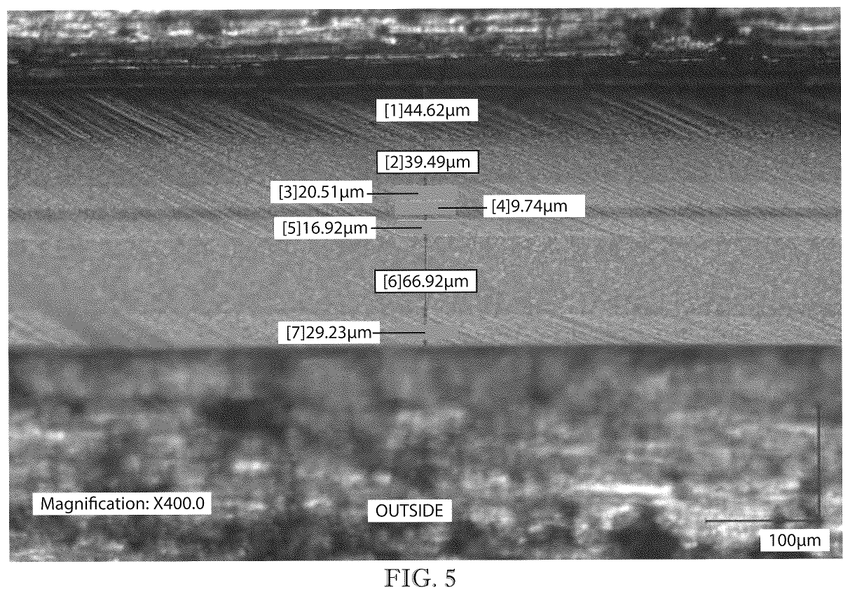

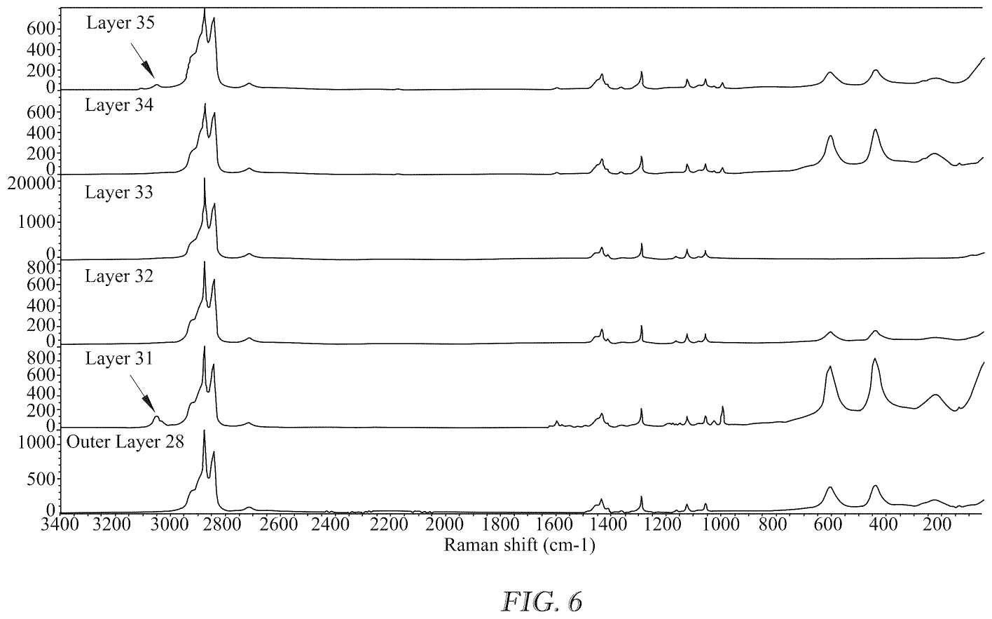

In one example, the polymeric tube 12 comprises a ground to ground measurement 36 as shown in FIG. 3. As described herein, the ground to ground (GTG) measurement refers to the distance from a contact point 38 of the polymeric tube 12 in contact with the ground to a second contact point 40 of the polymeric tube 12 in contact with the ground as shown in FIG. 3. This measurement may be taken from the contact point 38 to the second contact point 40 by measuring around the circumference of the polymeric tube 12, excluding the distance of the polymeric tube 12 that is in direct contact with the ground. The GTG measurement of the polymeric tube 12 may be dependent upon the dimensions, the material stored in the polymeric tube 12, the pressure and fill rate of the polymeric tube 12, the materials used to make the polymeric tube 12, and other relevant factors.

In one example, GTG measurement of the polymeric tube 12 may be dependent upon the diameter of the polymeric tube 12. In one example, a polymeric tube may have a particular GTG measurement or fall within one of several different ranges. In one example, a polymeric tube may have a GTG measurement that is about two-thirds of the polymeric tube 12 circumference. In another example, a polymeric tube may have a GTG measurement that is greater than about two-thirds of the polymeric tube 12 circumference. In another example, a polymeric tube 12 may have a diameter of 10 feet and a GTG that may fall within one of the following different ranges: greater than about 20 feet, greater than about 21 feet, greater than about 22 feet, greater than about 23 feet, greater than about 24 feet, about 20 feet to about 40 feet, about 22 feet to about 40 feet, about 24 feet to about 40 feet, about 20 feet to about 30 feet, about 22 feet to about 30 feet, and about 24 feet to about 30 feet. In another example, a polymeric tube 12 may have a diameter of 12 feet and a GTG that may fall within one of the following different ranges: greater than about 22 feet, greater than about 23 feet, greater than about 24 feet, greater than about 25 feet, greater than about 26 feet, greater than about 27 feet, greater than about 28 feet, greater than about 29 feet, about 20 feet to about 50 feet, about 24 feet to about 50 feet, about 26 feet to about 50 feet, about 28 feet to about 50 feet, about 22 feet to about 40 feet, about 24 feet to about 40 feet, about 26 feet to about 30 feet, and about 28 feet to about 40 feet.

Multilayer film 24, in one example, is a co-extruded film in which the layers 28, 31, 32, 33, 34, 35, and 30 each comprise a composition. Illustratively, each composition is formed by processing the formulation. Illustratively, each formulation of layer 28, 31, 32, 33, 34, 35, and 30 may be added to a hopper on an extrusion machine and heated to produce a molten material in the extruder. The molten material of each layer 28, 31, 32, 33, 34, 35, and 30 may be co-extruded to produce multilayer film 24. Films as disclosed herein may be made by many methods, including, but not limited to, blown film co-extrusion and cast film, co-extrusion processes, or any other suitable processes.

In one example, the multilayer film 24 may comprise a particular number of layers. In another example, the multilayer film 24 may comprise 7 layers comprising layer 28, 31, 32, 33, 34, 35, and 30. In another example, the multilayer film 24 may comprise layer 28, 31, 32, 33, 34, 35, and 30, arranged in any suitable order from outer to inner layer. In another example, the multilayer film 24 may comprise any suitable number of layers. The multilayer film 24 may comprise 3, 4, 5, 6, 7, 8, 9, or 10 layers.

In one example, multilayer film 24 is about 6 mils to about 10.5 mils thick. In another example, multilayer film 24 is about 6 mils to about 11 mils thick. Multilayer film 24 may be a particular thickness or fall within one of several different ranges. Multilayer film 24 thickness may fall within one of many different ranges. In a set of ranges, the thickness of multilayer film 24 is one of the following ranges: less than about 10.5 mils, less than about 8 mils, about 6 mils to about 10.5 mils, about 6 mils to about 11 mils, about 8 mils to about 10.5 mils, about 6 mils to about 9 mils, about 8 mils to about 9 mils, about 7 mils to about 9.5 mils, and about 6.5 mils to about 9.5 mils.

The multilayer film thickness may be a function of the diameter of the polymeric bag. In one example, a polymeric bag having a diameter of about 10 feet may have a multi-layer film thickness in a range of about 9 mil to about 9.5 mil. In another example, a polymeric bag having a diameter of about 12-14 feet may have a multi-layer film thickness in a range of about 9-10 mil. In yet another example, a polymeric bag having a diameter of about 6-9 feet may have a multi-layer film thickness in a range of about 8-9 mil.

In one example, the multilayer film 24 may comprise a polyethylene polymer. In another example, each layer of the multilayer film 24 comprises a polyethylene polymer. In another example, at least 5 layers of the multilayer film 24 comprise a polyethylene polymer. In another example, at least 6 layers of the multilayer film 24 comprise a polyethylene polymer. The multilayer film 24 may comprise a particular a weight percent of a polyethylene polymer or fall within one of several different ranges. The weight percent of the polyethylene polymer of the multilayer film 24 may be one of the following values: about 90%, about 91%, about 92%, about 93%, about 94%, about 95%, about 96%, about 97%, about 98%, and about 99%. It is within the present disclosure for the polyethylene polymer weight percent of the multilayer film 24 to fall within one of the following ranges: greater than about 85%, greater than about 90%, about 85% to about 99%, about 85% to about 95%, about 85% to about 90%, about 90% to about 99%, and about 90% to about 95%.

In one example, the multilayer film 24 comprises, for example, a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the multilayer film 24 may comprise NA942 resin available from Lyondell Basell, AGILITY 1000 Performance LDPE resin available from Dow, and AGILITY 1400 Performance LDPE resin available from Dow. In another example the multilayer film 24 may comprise Exceed resin available from Exxon or ExceedS resin available from Exxon.

In one example, the multilayer film 24 may further comprise a polyethylene-incompatible polymer. In another example, the multilayer film 24 may comprise a polyethylene polymer and a polyethylene-incompatible polymer. In another example, at least one layer of the multilayer film 24 comprises a polyethylene-incompatible polymer. In another example, at least 2 layers of the multilayer film 24 comprise a polyethylene-incompatible polymer. In another example, 1, 2, 3, or 4 layers of the multilayer film 24 comprise a polyethylene polymer. In another example, 1, 2, or 3 layers of the multilayer film 24 comprise a polyethylene polymer.

The term “incompatible polymer” may be understood to be a polymer that may form an immiscible blend with a second polymer to which it is being referred. An immiscible blend can also be referred to as a heterogeneous blend. An example, without limitation, of a second polymer to which an incompatible polymer is being referred is polyethylene (PE). An incompatible polymer described herein may form an immiscible blend with polyethylene, and may be referred to as a polyethylene-incompatible polymer. Examples of polyethylene-incompatible polymers, include but are not limited to, polypropylene, polystyrene, ethylene-vinyl alcohol copolymer, nylon (polyamide), and combinations thereof. A polyethylene-incompatible polymer described herein may be provided by fine particles. Examples of polyethylene-incompatible polymers, include but are not limited to, a polypropylene, a polypropylene fine particle composition, a polystyrene, a polystyrene fine particle composition, an ethylene vinyl alcohol copolymer, an ethylene vinyl alcohol copolymer fine particle composition, a nylon, a nylon fine particle composition, or any combination thereof.

The multilayer film 24 may comprise a particular a weight percent of a polyethylene-incompatible polymer or fall within one of several different ranges. The weight percent of the polyethylene-incompatible polymer of the multilayer film 24 may be one of the following values: about 1%, about 2%, about 3%, about 4%, about 5%, about 6%, about 7%, about 8%, about 9%, and about 10%. It is within the present disclosure for the polyethylene-incompatible polymer weight percent of the multilayer film 24 to fall within one of the following ranges: about 1% to about 10%, about 2% to about 10%, about 1% to about 6%, about 2% to about 6%, about 1% to about 5%, about 2% to about 5%, about 1.5% to about 6%, about 1.5% to about 5%, and about 1.5% to about 4%.

A feature of multilayer film 24 according to various aspects of the present disclosure is that the multilayer film 24 can be used to improve stretch properties such as stretch limit, creep resistance, or a combination thereof. Another feature of multilayer film 24 according to various aspects of the present disclosure is that the multilayer film 24 can be modified by the incorporation of a controlled quantity of a polyethylene-incompatible polymer blended with a polyethylene polymer.

In one example, the multilayer film 24 may comprise advantageous puncture-resistance and tear strength properties. In another example, the multilayer film 24 has a MD tear strength of greater than or equal to about 300 g/mil. In another example, the multilayer film 24 has a TD tear strength of greater than 400 g/mil. In another example, the multilayer film 24 has a puncture resistance of greater than 1,600 g.

Another feature of multilayer film 24 according to various aspects of the present disclosure is that the multilayer film 24 can be used to improve stretch properties, while retaining other properties such as melt strength, puncture-resistance, and bubble stability.

Another feature of multilayer film 24 according to various aspects of the present disclosure is that the multilayer film 24 can be recycled. Recyclable means that a material can be added (such as regrind) back into an extrusion or other formation process without segregation of components of the material. As an example, a multilayer film 24 does not have to be manipulated to remove one or more materials or components prior to re-entering the extrusion process. In one example, it may be advantageous to limit the weight percentage of the polyethylene-incompatible polymer of the multilayer film 24 to provide for the recycling of the multilayer film 24. In another example, it may be advantageous to limit the weight percentage of polystyrene polymer of the multilayer film 24 to provide for the recycling of the multilayer film 24. In some instances, a weight percent of the polystyrene polymer of the multilayer film 24 of less than about 10% may provide for the recycling of the multilayer film 24.

Another feature of multilayer film 24 according to various aspects of the present disclosure is that the multilayer film 24 can comprise recycled material. In an example, the multilayer film 24 can comprise PIR (post industrial recycled) resin, PCR (post consumer recycled) resin, or combinations thereof. In an example, the outer layer 28 of the multilayer film 24 can comprise PIR (post industrial recycled) resin, PCR (post consumer recycled) resin, or combinations thereof.

In another example, it may be advantageous to limit the weight percentage of the polyethylene-incompatible polymer of the multilayer film 24 to control material cost. In one example, it may be advantageous to limit the weight percentage of the polyethylene-incompatible polymer of the multilayer film 24 to control cost of the multilayer film 24. In another example, it may be advantageous to limit the weight percentage of polystyrene polymer of the multilayer film 24 to control cost of the multilayer film 24. In some instances, a weight percent of the polystyrene polymer of the multilayer film 24 of less than about 10% may control cost of the multilayer film 24.

In one example, the multilayer film 24 may further comprise an additive. In another example, the additive comprises a pigment, a UV inhibitor, a slip agent, a process aid, or any combination thereof. In one example, each layer of the multilayer film 24 comprises an additive. In another example, at least 3 layers of the multilayer film 24 comprise an additive. In another example, 3, 4, 5, 6, or 7 layers of the multilayer film 24 comprise an additive. In another example, 4, 5, 6, or 7 layers of the multilayer film 24 comprise an additive.

The multilayer film 24 may comprise a particular percentage of stretch in comparison to its original length. In one example, the multilayer film 24 has a stretch of less than or equal to 15% in a 24 hour high temperature creep-resistance test. In another example, the multilayer film 24 has a stretch of less than or equal to 12% in a 24 hour high temperature creep-resistance test. It is within the present disclosure for percentage of stretch in a 24 hour high temperature creep-resistance test of the multilayer film 24 to fall within one of the following ranges: about 0% to about 15%, about 0% to about 12%, about 0% to about 10%, about 5% to about 15%, about 10% to about 15%, about 5% to about 12%, about 5% to about 10%, about 10% to about 15%, and about 10% to about 12%.

Outer Layer 28

The outer layer 28 of the multilayer film 24 comprises, for example, a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the outer layer 28 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the outer layer 28 of the multilayer film 24 may comprise NA942 resin available from Lyondell Basell, AGILITY 1000 Performance LDPE resin available from Dow, and AGILITY 1400 Performance LDPE resin available from Dow. In another example, the outer layer 28 of the multilayer film 24 may comprise Exceed resin available from Exxon or ExceedS resin available from Exxon.

In another example, the outer layer 28 of the multilayer film 24 further comprises a polyethylene-incompatible polymer. In another example, the polyethylene-incompatible polymer of the outer layer 28 of the multilayer film 24 may comprise polypropylene, polystyrene, ethylene-vinyl alcohol copolymer, nylon, or any other suitable material. In one example, the polyethylene-incompatible polymer is polystyrene. In another example, the polyethylene-incompatible polymer may comprise fine particles. In one example, the polyethylene-incompatible polymer may be provided and available by VOID Technologies. In another example, the polyethylene-incompatible polymer may be Styron® 675, supplied by Americas Styrenics.

In another example, the outer layer 28 of the multilayer film 24 further comprises an additive. In one example, the additive comprises a UV inhibitor. In one example, the outer layer 28 of the multilayer film 24 may comprise 103621 MB0002 F715 Silage UV PE MB resin available from Ampacet Co. In another example, the additive comprises a slip or process aid. In one example, the outer layer 28 of the multilayer film 24 may comprise 807016 Slip PE MB resin available from Ampacet Co.

In another example, the outer layer 28 comprises of the multilayer film 24 the polyethylene polymer and a polyethylene-incompatible polymer. In another example, the outer layer 28 comprises the polyethylene polymer and the UV inhibitor. In another example, the outer layer 28 comprises the polyethylene polymer and the slip or process aid. In another example, the outer layer 28 comprises the polyethylene polymer, the polyethylene-incompatible polymer, and the UV inhibitor. In another example, the outer layer 28 comprises the polyethylene polymer, the polyethylene-incompatible polymer, and the slip or process aid. In another example, the outer layer 28 comprises the polyethylene polymer, the polyethylene-incompatible polymer, the UV inhibitor, and the slip or process aid.

In one example, polyethylene polymer comprises a weight percent of about 74% of the outer layer 28 of the multilayer film 24. The polyethylene polymer weight percent of the outer layer 28 may be one of several different percentages or fall within one of several different ranges. The weight percent of the polyethylene polymer of the outer layer 28 may be one of the following values: about 70%, about 71%, about 72%, about 73%, about 74%, about 75%, about 76%, about 77%, about 78%, about 79%, and about 80%. The weight percent of the polyethylene polymer of the outer layer 28 may be one of the following values: about 81%, about 82%, about 83%, about 84%, about 85%, about 86%, about 87%, about 88%, about 89%, and about 90%. It is within the present disclosure for the polyethylene polymer weight percent of the outer layer 28 to fall within one of the following ranges: greater than about 70%, about 70% to about 90%, less than about 90%, about 70% to about 80%, and about 70% to about 75%. It is within the present disclosure for the polyethylene polymer weight percent of the outer layer 28 to fall within one of the following ranges: greater than about 80%, about 80% to about 99%, less than about 99%, about 85% to about 99%, and about 90% to about 99%. In one example, the remaining weight percentage comprises the polyethylene-incompatible polymer. In another example, the remaining weight percentage comprises the polyethylene-incompatible polymer and the UV inhibitor. In another example, the remaining weight percentage comprises the polyethylene-incompatible polymer and the slip or process aid. In another example, the remaining weight percentage comprises the polyethylene-incompatible polymer, the UV inhibitor, and the slip or process aid.

In one example, polyethylene-incompatible polymer comprises a weight percent of about 20% of the outer layer 28 of the multilayer film 24. The polyethylene-incompatible polymer weight percent of the outer layer 28 may be one of several different percentages or fall within one of several different ranges. The weight percent of the polyethylene-incompatible polymer of the outer layer 28 may be one of the following values: about 15%, about 16%, about 17%, about 18%, about 19%, about 20%, about 21%, about 22%, about 23%, about 24%, and about 25%. It is within the present disclosure for the polyethylene-incompatible polymer weight percent of the outer layer 28 to fall within one of the following ranges: about 10% to about 40%, about 15% to about 40%, about 10% to about 30%, about 15% to about 30%, and about 15% to about 25%.

In one example, the UV inhibitor comprises a weight percent of about 3% of the outer layer 28 of the multilayer film 24. The UV inhibitor weight percent of the outer layer 28 may be one of several different percentages or fall within one of several different ranges. The weight percent of the UV inhibitor of the outer layer 28 may be one of the following values: about 1%, about 2%, about 3%, about 4%, about 5%, about 6%, about 7%, about 8%, about 9%, and about 10%. It is within the present disclosure for the UV inhibitor weight percent of the outer layer 28 to fall within one of the following ranges: less than about 10%, less than about 5%, about 1% to about 10%, about 2% to about 10%, about 1% to about 8%, about 1% to about 5%, and about 2% to about 5%.

In one example, the slip or process aid comprises a weight percent of about 3% of the outer layer 28 of the multilayer film 24. The slip or process aid weight percent of the outer layer 28 may be one of several different percentages or fall within one of several different ranges. The weight percent of the slip or process aid of the outer layer 28 may be one of the following values: about 1%, about 2%, about 3%, about 4%, about 5%, about 6%, about 7%, about 8%, about 9%, and about 10%. It is within the present disclosure for the slip or process aid weight percent of the outer layer 28 to fall within one of the following ranges: less than about 10%, less than about 5%, about 1% to about 10%, about 2% to about 10%, about 1% to about 8%, about 1% to about 5%, and about 2% to about 5%.

In one example, the outer layer 28 of the multilayer film 24 comprises a thickness of about 19% of the total thickness of multilayer film 24. In another example, the outer layer 28 of the multilayer film 24 comprises a thickness of about 20% of the total thickness of multilayer film 24. The outer layer 28 may be one of several different percentages of the total thickness of multilayer film 24 or fall within one of several different ranges. The percentage thickness of outer layer 28 of the total thickness of multilayer film 24 may be one of the following values: about 15%, about 16%, about 17%, about 18%, about 19%, about 20%, about 21%, about 22%, about 23%, about 24%, and about 25%. It is within the present disclosure for the thickness of the outer layer 28 of the total thickness of multilayer film 24 to fall within one of the following ranges: less than about 25%, about 15% to about 25%, less than about 20%, about 15% to about 20%, and about 18% to about 20%.

First Core Layer 31

In one example, the layer 31 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the layer 31 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the layer 31 of the multilayer film 24 may comprise NA942 resin available from Lyondell Basell, AGILITY 1000 Performance LDPE resin available from Dow, and AGILITY 1400 Performance LDPE resin available from Dow. In another example, the layer 31 of the multilayer film 24 may comprise Exceed resin available from Exxon or ExceedS resin available from Exxon.

In another example, the layer 31 of the multilayer film 24 further comprises a polyethylene-incompatible polymer. In another example, the polyethylene-incompatible polymer of the layer 31 of the multilayer film 24 may comprise polypropylene, polystyrene, ethylene-vinyl alcohol copolymer, nylon, or any other suitable material. In one example, the polyethylene-incompatible polymer is polystyrene. In another example, the polyethylene-incompatible polymer may comprise fine particles. In one example, the polyethylene-incompatible polymer may be provided and available by VOID Technologies. In another example, the polyethylene-incompatible polymer may be Styron® 675, supplied by Americas Styrenics.

In another example, the layer 31 of the multilayer film 24 further comprises an additive. In one example, the additive comprises a UV inhibitor. In one example, the layer 31 of the multilayer film 24 may comprise 103621 MB0002 F715 Silage UV PE MB resin available from Ampacet Co. In another example, the additive comprises a pigment. The pigment may be a white pigment. The white pigment may comprise CaCO₃, BaSO₄, and TiO₂. In one example, the layer 31 of the multilayer film 24 may comprise 1100462 NP White PE MB resin available from Ampacet Co. or 112412 MB0006 F97W PE MB resin available from Ampacet Co.

In another example, the layer 31 comprises of the multilayer film 24 the polyethylene polymer and a polyethylene-incompatible polymer. In another example, the layer 31 comprises of the multilayer film 24 the polyethylene polymer and the UV inhibitor. In another example, the layer 31 comprises the polyethylene polymer and the pigment. In another example, the layer 31 comprises the polyethylene polymer, the UV inhibitor, and the pigment. In another example, the layer 31 comprises the polyethylene polymer, polyethylene-incompatible polymer, the UV inhibitor, and the pigment.

In one example, polyethylene polymer comprises a weight percent of about 88% of the layer 31 of the multilayer film 24. The polyethylene polymer weight percent of the layer 31 may be one of several different percentages or fall within one of several different ranges. The weight percent of the polyethylene polymer of the layer 31 may be one of the following values: about 85%, about 86%, about 87%, about 88%, about 89%, about 90%, about 91%, about 92%, about 93%, about 94%, and about 95%. The weight percent of the polyethylene polymer of the layer 31 may be one of the following values: about 81%, about 82%, about 83%, about 84%, about 85%, about 86%, about 87%, about 88%, about 89%, and about 90%. It is within the present disclosure for the polyethylene polymer weight percent of the layer 31 to fall within one of the following ranges: greater than about 75%, about 75% to about 95%, less than about 95%, about 80% to about 95%, and about 85% to about 90%. It is within the present disclosure for the polyethylene polymer weight percent of the layer 31 to fall within one of the following ranges: greater than about 80%, about 80% to about 99%, less than about 99%, about 85% to about 99%, and about 90% to about 99%. In one example, the remaining weight percentage comprises the polyethylene-incompatible polymer. In one example, the remaining weight percentage comprises the UV inhibitor. In another example, the remaining weight percentage comprises the UV inhibitor and the pigment.

In one example, polyethylene-incompatible polymer comprises a weight percent of about 7% of the layer 31 of the multilayer film 24. The polyethylene-incompatible polymer weight percent of the layer 31 may be one of several different percentages or fall within one of several different ranges. The weight percent of the polyethylene-incompatible polymer of the layer 31 may be one of the following values: about 1%, about 2%, about 3%, about 4%, about 5%, about 6%, about 7%, about 8%, about 9%, and about 10%. It is within the present disclosure for the polyethylene-incompatible polymer weight percent of the layer 31 to fall within one of the following ranges: about 1% to about 10%, about 2% to about 10%, about 3% to about 10%, about 5% to about 10%, about 1% to about 8%, and about 2% to about 8%.

In one example, the UV inhibitor comprises a weight percent of about 3% of the layer 31 of the multilayer film 24. The UV inhibitor weight percent of the layer 31 may be one of several different percentages or fall within one of several different ranges. The weight percent of the UV inhibitor of the layer 31 may be one of the following values: about 1%, about 2%, about 3%, about 4%, about 5%, about 6%, about 7%, about 8%, about 9%, and about 10%. It is within the present disclosure for the UV inhibitor weight percent of the layer 31 to fall within one of the following ranges: less than about 10%, less than about 5%, about 1% to about 10%, about 2% to about 10%, about 1% to about 8%, about 1% to about 5%, and about 2% to about 5%.

In one example, the pigment comprises a weight percent of about 9% of the layer 31 of the multilayer film 24. The pigment weight percent of the layer 31 may be one of several different percentages or fall within one of several different ranges. The weight percent of the pigment of the layer 31 may be one of the following values: about 5%, about 6%, about 7%, about 8%, about 9%, about 10%, about 11%, about 12%, about 13%, about 14%, and about 15%. It is within the present disclosure for the pigment weight percent of the layer 31 to fall within one of the following ranges: less than about 15%, less than about 10%, about 1% to about 15%, about 1% to about 10%, about 5% to about 15%, about 5% to about 10%, and about 8% to about 10%.

In one example, the layer 31 of the multilayer film 24 comprises a thickness of about 21% of the total thickness of multilayer film 24. In another example, the layer 31 of the multilayer film 24 comprises a thickness of about 20% of the total thickness of multilayer film 24. The layer 31 may be one of several different percentages of the total thickness of multilayer film 24 or fall within one of several different ranges. The percentage thickness of layer 31 of the total thickness of multilayer film 24 may be one of the following values: about 15%, about 16%, about 17%, about 18%, about 19%, about 20%, about 21%, about 22%, about 23%, about 24%, and about 25%. It is within the present disclosure for the thickness of the layer 31 of the total thickness of multilayer film 24 to fall within one of the following ranges: less than about 25%, about 15% to about 25%, less than about 22%, about 20% to about 25%, and about 20% to about 22%.

Second Core Layer 32

In one example, the layer 32 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the layer 32 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the layer 32 of the multilayer film 24 may comprise NA942 resin available from Lyondell Basell, AGILITY 1000 Performance LDPE resin available from Dow, and AGILITY 1400 Performance LDPE resin available from Dow. In another example, the layer 32 of the multilayer film 24 may comprise Exceed resin available from Exxon or ExceedS resin available from Exxon.

In another example, the layer 32 of the multilayer film 24 further comprises a polyethylene-incompatible polymer. In another example, the polyethylene-incompatible polymer of the layer 32 of the multilayer film 24 may comprise polypropylene, polystyrene, ethylene-vinyl alcohol copolymer, nylon, or any other suitable material. In one example, the polyethylene-incompatible polymer is polystyrene. In another example, the polyethylene-incompatible polymer may comprise fine particles. In one example, the polyethylene-incompatible polymer may be provided and available by VOID Technologies. In another example, the polyethylene-incompatible polymer may be Styron® 675, supplied by Americas Styrenics.

In another example, the layer 32 of the multilayer film 24 further comprises an additive. In one example, the additive comprises a UV inhibitor. In one example, the layer 32 of the multilayer film 24 may comprise 103621 MB0002 F715 Silage UV PE MB resin available from Ampacet Co. In another example, the additive comprises a pigment. The pigment may be a white pigment. The white pigment may comprise CaCO₃, BaSO₄, and TiO₂. In one example, the layer 32 of the multilayer film 24 may comprise 1100462 NP White PE MB resin available from Ampacet Co. or 112412 MB0006 F97W PE MB resin available from Ampacet Co.

In another example, the layer 32 comprises of the multilayer film 24 the polyethylene polymer and a polyethylene-incompatible polymer. In another example, the layer 32 comprises the polyethylene polymer and the UV inhibitor. In another example, the layer 32 comprises the polyethylene polymer and the pigment. In another example, the layer 32 comprises the polyethylene polymer, the polyethylene-incompatible polymer, and the UV inhibitor. In another example, the layer 32 comprises the polyethylene polymer, the polyethylene-incompatible polymer, and the pigment. In another example, the layer 32 comprises the polyethylene polymer, the polyethylene-incompatible polymer, the UV inhibitor, and the pigment.

In one example, polyethylene polymer comprises a weight percent of about 68% of the layer 32 of the multilayer film 24. The polyethylene polymer weight percent of the layer 32 may be one of several different percentages or fall within one of several different ranges. The weight percent of the polyethylene polymer of the layer 32 may be one of the following values: about 65%, about 66%, about 67%, about 68%, about 69%, about 70%, about 71%, about 72%, about 73%, about 74%, and about 75%. It is within the present disclosure for the polyethylene polymer weight percent of the layer 32 to fall within one of the following ranges: greater than about 60%, about 60% to about 90%, less than about 90%, about 60% to about 70%, 65% to about 80%, and about 65% to about 70%. In one example, the remaining weight percentage comprises the polyethylene-incompatible polymer. In another example, the remaining weight percentage comprises the polyethylene-incompatible polymer and the UV inhibitor. In another example, the remaining weight percentage comprises the polyethylene-incompatible polymer and the pigment. In another example, the remaining weight percentage comprises the polyethylene-incompatible polymer, the UV inhibitor, and the pigment.

In one example, polyethylene-incompatible polymer comprises a weight percent of about 20% of the layer 32 of the multilayer film 24. The polyethylene-incompatible polymer weight percent of the layer 32 may be one of several different percentages or fall within one of several different ranges. The weight percent of the polyethylene-incompatible polymer of the layer 32 may be one of the following values: about 15%, about 16%, about 17%, about 18%, about 19%, about 20%, about 21%, about 22%, about 23%, about 24%, and about 25%. It is within the present disclosure for the polyethylene-incompatible polymer weight percent of the layer 32 to fall within one of the following ranges: about 10% to about 40%, about 15% to about 40%, about 10% to about 30%, about 15% to about 30%, and about 15% to about 25%.

In one example, the UV inhibitor comprises a weight percent of about 3% of the layer 32 of the multilayer film 24. The UV inhibitor weight percent of the layer 32 may be one of several different percentages or fall within one of several different ranges. The weight percent of the UV inhibitor of the layer 32 may be one of the following values: about 1%, about 2%, about 3%, about 4%, about 5%, about 6%, about 7%, about 8%, about 9%, and about 10%. It is within the present disclosure for the UV inhibitor weight percent of the layer 32 to fall within one of the following ranges: less than about 10%, less than about 5%, about 1% to about 10%, about 2% to about 10%, about 1% to about 8%, about 1% to about 5%, and about 2% to about 5%.

In one example, the pigment comprises a weight percent of about 9% of the layer 32 of the multilayer film 24. The pigment weight percent of the layer 32 may be one of several different percentages or fall within one of several different ranges. The weight percent of the pigment of the layer 32 may be one of the following values: about 5%, about 6%, about 7%, about 8%, about 9%, about 10%, about 11%, about 12%, about 13%, about 14%, and about 15%. It is within the present disclosure for the pigment weight percent of the layer 32 to fall within one of the following ranges: less than about 15%, less than about 10%, about 1% to about 15%, about 1% to about 10%, about 5% to about 15%, about 5% to about 10%, and about 8% to about 10%.

In one example, the layer 32 of the multilayer film 24 comprises a thickness of about 8% of the total thickness of multilayer film 24. In another example, the layer 32 of the multilayer film 24 comprises a thickness of about 8.5% of the total thickness of multilayer film 24. The layer 32 may be one of several different percentages of the total thickness of multilayer film 24 or fall within one of several different ranges. The percentage thickness of layer 32 of the total thickness of multilayer film 24 may be one of the following values: about 5%, about 6%, about 7%, about 8%, about 9%, about 10%, about 11%, about 12%, about 13%, about 14%, and about 15%. It is within the present disclosure for the thickness of the layer 32 of the total thickness of multilayer film 24 to fall within one of the following ranges: less than about 15%, about 1% to about 15%, less than about 10%, about 5% to about 15%, and about 5% to about 10%.

Third Core Layer 33

In one example, the layer 33 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer is high density polyethylene polymer. In another example, the polyethylene polymer may be a metallocene polyethylene polymer. In another example, the layer 33 of the multilayer film 24 may comprise ELITE 5940G resin available from Dow. In another example, the layer 33 of the multilayer film 24 may comprise Exceed resin available from Exxon or ExceedS resin available from Exxon.

In another example, the layer 33 of the multilayer film 24 further comprises an additive. In one example, the additive comprises a UV inhibitor. In one example, the layer 33 of the multilayer film 24 may comprise 103621 MB0002 F715 Silage UV PE MB resin available from Ampacet Co. In another example, the layer 33 comprises the polyethylene polymer and the UV inhibitor.

In one example, polyethylene polymer comprises a weight percent of about 97% of the layer 33 of the multilayer film 24. The polyethylene polymer weight percent of the layer 33 may be one of several different percentages or fall within one of several different ranges. The weight percent of the polyethylene polymer of the layer 33 may be one of the following values: about 90%, about 91%, about 92%, about 93%, about 94%, about 95%, about 96%, about 97%, about 98%, about 99%, and about 100%. It is within the present disclosure for the polyethylene polymer weight percent of the inner layer 30 to fall within one of the following ranges: greater than about 90%, about 80% to about 100%, less than about 100%, about 90% to about 100%, and about 92% to about 98%. In one example, the remaining weight percentage comprises the UV inhibitor.

In one example, the UV inhibitor comprises a weight percent of about 3% of the layer 33 of the multilayer film 24. The UV inhibitor weight percent of the layer 33 may be one of several different percentages or fall within one of several different ranges. The weight percent of the UV inhibitor of the layer 33 may be one of the following values: about 1%, about 2%, about 3%, about 4%, about 5%, about 6%, about 7%, about 8%, about 9%, and about 10%. It is within the present disclosure for the UV inhibitor weight percent of the layer 33 to fall within one of the following ranges: less than about 10%, less than about 5%, about 1% to about 10%, about 2% to about 10%, about 1% to about 8%, about 1% to about 5%, and about 2% to about 5%.

In one example, the layer 33 of the multilayer film 24 comprises a thickness of about 4% of the total thickness of multilayer film 24. The layer 33 may be one of several different percentages of the total thickness of multilayer film 24 or fall within one of several different ranges. The percentage thickness of layer 33 of the total thickness of multilayer film 24 may be one of the following values: about 1%, about 2%, about 3%, about 4%, about 5%, about 6%, about 7%, about 8%, about 9%, and about 10%. It is within the present disclosure for the thickness of the layer 33 of the total thickness of multilayer film 24 to fall within one of the following ranges: less than about 10%, about 1% to about 10%, less than about 8%, about 1% to about 8%, and about 2% to about 8%.

Fourth Core Layer 34

In one example, the layer 34 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the layer 34 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the layer 34 of the multilayer film 24 may comprise NA942 resin available from Lyondell Basell, AGILITY 1000 Performance LDPE resin available from Dow, and AGILITY 1400 Performance LDPE resin available from Dow. In another example, the layer 34 of the multilayer film 24 may comprise Exceed resin available from Exxon or ExceedS resin available from Exxon.

In another example, the layer 34 of the multilayer film 24 further comprises a polyethylene-incompatible polymer. In another example, the polyethylene-incompatible polymer of the layer 34 of the multilayer film 24 may comprise polypropylene, polystyrene, ethylene-vinyl alcohol copolymer, nylon, or any other suitable material. In one example, the polyethylene-incompatible polymer is polystyrene. In another example, the polyethylene-incompatible polymer may comprise fine particles. In one example, the polyethylene-incompatible polymer may be provided and available by VOID Technologies. In another example, the polyethylene-incompatible polymer may be Styron® 675, supplied by Americas Styrenics.

In another example, the layer 34 of the multilayer film 24 further comprises an additive. In one example, the additive comprises a UV inhibitor. In one example, the layer 34 of the multilayer film 24 may comprise 103621 MB0002 F715 Silage UV PE MB resin available from Ampacet Co. In another example, the additive comprises a pigment. The pigment may be a white pigment. The white pigment may comprise CaCO₃, BaSO₄, and TiO₂. In one example, the layer 34 of the multilayer film 24 may comprise 1100462 NP White PE MB resin available from Ampacet Co. or 112412 MB0006 F97W PE MB resin available from Ampacet Co.

In another example, the layer 34 comprises of the multilayer film 24 the polyethylene polymer and a polyethylene-incompatible polymer. In another example, the layer 34 comprises the polyethylene polymer and the UV inhibitor. In another example, the layer 34 comprises the polyethylene polymer and the pigment. In another example, the layer 34 comprises the polyethylene polymer, the polyethylene-incompatible polymer, and the UV inhibitor. In another example, the layer 34 comprises the polyethylene polymer, the polyethylene-incompatible polymer, and the pigment. In another example, the layer 34 comprises the polyethylene polymer, the polyethylene-incompatible polymer, the UV inhibitor, and the pigment.

In one example, polyethylene polymer comprises a weight percent of about 68% of the layer 34 of the multilayer film 24. The polyethylene polymer weight percent of the layer 34 may be one of several different percentages or fall within one of several different ranges. The weight percent of the polyethylene polymer of the layer 34 may be one of the following values: about 65%, about 66%, about 67%, about 68%, about 69%, about 70%, about 71%, about 72%, about 73%, about 74%, and about 75%. It is within the present disclosure for the polyethylene polymer weight percent of the layer 34 to fall within one of the following ranges: greater than about 60%, about 60% to about 90%, less than about 90%, about 60% to about 70%, 65% to about 80%, and about 65% to about 70%. In one example, the remaining weight percentage comprises the polyethylene-incompatible polymer. In another example, the remaining weight percentage comprises the polyethylene-incompatible polymer and the UV inhibitor. In another example, the remaining weight percentage comprises the polyethylene-incompatible polymer and the pigment. In another example, the remaining weight percentage comprises the polyethylene-incompatible polymer, the UV inhibitor, and the pigment.

In one example, polyethylene-incompatible polymer comprises a weight percent of about 20% of the layer 34 of the multilayer film 24. The polyethylene-incompatible polymer weight percent of the layer 34 may be one of several different percentages or fall within one of several different ranges. The weight percent of the polyethylene-incompatible polymer of the layer 34 may be one of the following values: about 15%, about 16%, about 17%, about 18%, about 19%, about 20%, about 21%, about 22%, about 23%, about 24%, and about 25%. It is within the present disclosure for the polyethylene-incompatible polymer weight percent of the layer 34 to fall within one of the following ranges: about 10% to about 40%, about 15% to about 40%, about 10% to about 30%, about 15% to about 30%, and about 15% to about 25%.

In one example, the UV inhibitor comprises a weight percent of about 3% of the layer 34 of the multilayer film 24. The UV inhibitor weight percent of the layer 34 may be one of several different percentages or fall within one of several different ranges. The weight percent of the UV inhibitor of the layer 34 may be one of the following values: about 1%, about 2%, about 3%, about 4%, about 5%, about 6%, about 7%, about 8%, about 9%, and about 10%. It is within the present disclosure for the UV inhibitor weight percent of the layer 34 to fall within one of the following ranges: less than about 10%, less than about 5%, about 1% to about 10%, about 2% to about 10%, about 1% to about 8%, about 1% to about 5%, and about 2% to about 5%.

In one example, the pigment comprises a weight percent of about 9% of the layer 34 of the multilayer film 24. The pigment weight percent of the layer 34 may be one of several different percentages or fall within one of several different ranges. The weight percent of the pigment of the layer 34 may be one of the following values: about 5%, about 6%, about 7%, about 8%, about 9%, about 10%, about 11%, about 12%, about 13%, about 14%, and about 15%. It is within the present disclosure for the pigment weight percent of the layer 34 to fall within one of the following ranges: less than about 15%, less than about 10%, about 1% to about 15%, about 1% to about 10%, about 5% to about 15%, about 5% to about 10%, and about 8% to about 10%.

In one example, the layer 34 of the multilayer film 24 comprises a thickness of about 8% of the total thickness of multilayer film 24. In another example, the layer 34 of the multilayer film 24 comprises a thickness of about 8.5% of the total thickness of multilayer film 24. The layer 34 may be one of several different percentages of the total thickness of multilayer film 24 or fall within one of several different ranges. The percentage thickness of layer 34 of the total thickness of multilayer film 24 may be one of the following values: about 5%, about 6%, about 7%, about 8%, about 9%, about 10%, about 11%, about 12%, about 13%, about 14%, and about 15%. It is within the present disclosure for the thickness of the layer 34 of the total thickness of multilayer film 24 to fall within one of the following ranges: less than about 15%, about 1% to about 15%, less than about 10%, about 5% to about 15%, and about 5% to about 10%.

Fifth Core Layer 35

In one example, the layer 35 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the layer 35 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the layer 35 of the multilayer film 24 may comprise NA942 resin available from Lyondell Basell, AGILITY 1000 Performance LDPE resin available from Dow, and AGILITY 1400 Performance LDPE resin available from Dow. In another example, the layer 35 of the multilayer film 24 may comprise Exceed resin available from Exxon or ExceedS resin available from Exxon.

In another example, the layer 35 of the multilayer film 24 further comprises an additive. In one example, the additive comprises a pigment. The pigment may be carbon black. In one example, the layer 35 of the multilayer film 24 may comprise 191029 FDA Black PE MB resin available from Ampacet Co.

In one example, polyethylene polymer comprises a weight percent of about 95% of the layer 35 of the multilayer film 24. The polyethylene polymer weight percent of the layer 35 may be one of several different percentages or fall within one of several different ranges. The weight percent of the polyethylene polymer of the layer 35 may be one of the following values: about 90%, about 91%, about 92%, about 93%, about 94%, about 95%, about 96%, about 97%, about 98%, about 99%, and about 100%. It is within the present disclosure for the polyethylene polymer weight percent of the layer 35 to fall within one of the following ranges: greater than about 90%, about 80% to about 100%, less than about 100%, about 90% to about 100%, and about 92% to about 98%. In one example, the remaining weight percentage comprises the pigment.

In one example, the pigment comprises a weight percent of about 5% of the layer 35 of the multilayer film 24. The pigment weight percent of the layer 35 may be one of several different percentages or fall within one of several different ranges. The weight percent of the pigment of the layer 35 may be one of the following values: about 1%, about 2%, about 3%, about 4%, about 5%, about 6%, about 7%, about 8%, about 9%, and about 10%. It is within the present disclosure for the pigment weight percent of the layer 35 to fall within one of the following ranges: less than about 10%, less than about 8%, about 1% to about 10%, about 1% to about 8%, about 2% to about 8%, about 2% to about 6%, and about 4% to about 6%.

In one example, the layer 35 of the multilayer film 24 comprises a thickness of about 21% of the total thickness of multilayer film 24. In another example, the layer 35 of the multilayer film 24 comprises a thickness of about 20% of the total thickness of multilayer film 24. The layer 35 may be one of several different percentages of the total thickness of multilayer film 24 or fall within one of several different ranges. The percentage thickness of layer 35 of the total thickness of multilayer film 24 may be one of the following values: about 15%, about 16%, about 17%, about 18%, about 19%, about 20%, about 21%, about 22%, about 23%, about 24%, and about 5%. It is within the present disclosure for the thickness of the layer 35 of the total thickness of multilayer film 24 to fall within one of the following ranges: less than about 25%, about 15% to about 25%, less than about 20%, about 15% to about 20%, and about 18% to about 20%.

Inner Layer 30

In one example, the inner layer 30 of the multilayer film 24 comprises a polyethylene polymer. In another example, the polyethylene polymer may be low density polyethylene (LDPE), medium density polyethylene (MDPE), or high density polyethylene (HDPE). In another example, the polyethylene polymer may be a high strength polyethylene polymer. In another example, the polyethylene polymer may be a metallocene polyethylene polymer. In another example, the inner layer 30 of the multilayer film 24 may comprise MarFlex 7105D resin available from Chevron Philips Chemical Co., Marflex D139 resin available from Chevron Philips Chemical Co., DOWLEX 2645G resin available from Dow, DOWLEX 2045 resin available from Dow, ELITE AT 6101 resin available from Dow, Enable 23-05 resin available from Exxon, Enable 20-05CH resin available from Exxon, XUS 61528.45 resin available from Dow, and XUS 60901.53 resin available from Dow. In another example, the inner layer 30 of the multilayer film 24 may comprise NA942 resin available from Lyondell Basell, AGILITY 1000 Performance LDPE resin available from Dow, and AGILITY 1400 Performance LDPE resin available from Dow. In another example, the inner layer 30 of the multilayer film 24 may comprise Exceed resin available from Exxon or ExceedS resin available from Exxon.

In another example, the inner layer 30 of the multilayer film 24 further comprises an additive. In one example, the additive comprises a pigment. The pigment may be carbon black. In one example, the inner layer 30 of the multilayer film 24 may comprise 191029 FDA Black PE MB resin available from Ampacet Co.

In one example, polyethylene polymer comprises a weight percent of about 95% of the inner layer 30 of the multilayer film 24. The polyethylene polymer weight percent of the inner layer 30 may be one of several different percentages or fall within one of several different ranges. The weight percent of the polyethylene polymer of the inner layer 30 may be one of the following values: about 90%, about 91%, about 92%, about 93%, about 94%, about 95%, about 96%, about 97%, about 98%, about 99%, and about 100%. It is within the present disclosure for the polyethylene polymer weight percent of the inner layer 30 to fall within one of the following ranges: greater than about 90%, about 80% to about 100%, less than about 100%, about 90% to about 100%, and about 92% to about 98%. In one example, the remaining weight percentage comprises the pigment.

In one example, the pigment comprises a weight percent of about 5% of the inner layer 30 of the multilayer film 24. The pigment weight percent of the inner layer 30 may be one of several different percentages or fall within one of several different ranges. The weight percent of the pigment of the inner layer 30 may be one of the following values: about 1%, about 2%, about 3%, about 4%, about 5%, about 6%, about 7%, about 8%, about 9%, and about 10%. It is within the present disclosure for the pigment weight percent of the inner layer 30 to fall within one of the following ranges: less than about 10%, less than about 8%, about 1% to about 10%, about 1% to about 8%, about 2% to about 8%, about 2% to about 6%, and about 4% to about 6%.

In one example, the inner layer 30 of the multilayer film 24 comprises a thickness of about 19% of the total thickness of multilayer film 24. The inner layer 30 may be one of several different percentages of the total thickness of multilayer film 24 or fall within one of several different ranges. The percentage thickness of inner layer 30 of the total thickness of multilayer film 24 may be one of the following values: about 15%, about 16%, about 17%, about 18%, about 19%, about 20%, about 21%, about 22%, about 23%, about 24%, and about 5%. It is within the present disclosure for the thickness of the inner layer 30 of the total thickness of multilayer film 24 to fall within one of the following ranges: less than about 25%, about 15% to about 25%, less than about 20%, about 15% to about 20%, and about 18% to about 20%.

Multilayer films and individual layers of multilayer films in accordance with the present disclosure may have various characteristics including, but not limited to, an average weight percentage, an average thickness, a density, a tear strength, a puncture resistance, a creep resistance, an opacity, and any characteristic as described herein. Any layer of the multilayer film 24 may comprise a suitable polymer composition that will provide any number of suitable film characteristics of a multilayer film.

Agricultural films, wraps and bags provide the strength and reliability for the effective harvesting and packaging of a wide range of crops.

The present disclosure relates to an innovative improvement in the composition and construction of silage and grain bags used in agriculture. Silage and grain bags may be used in modem agriculture for efficient storage and preservation of crops.

Comparative silage and grain bags may be formed solely from polyethylene resins, which possess certain limitations, particularly concerning their stretch limit during various conditions. The comparative bags are burdened in properties such as low stretch limit and poor creep resistance. Further, the manufacture of the films forming comparative bags is burdened with production disadvantages such as high backpressure during the extrusion process producing films with high polyethylene content.

Therefore, new films for use in silage and grain bags, in accordance with the present disclosure, mitigate stretching during challenging conditions. The development of new film compositions for use in silage and grain bags with improved stretch limit, puncture resistance, and creep resistance are provided by the present disclosure.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value.

### EXAMPLES

### Example 1

An exemplary storage bag formed from multilayer film 1 in accordance with certain aspects of the present disclosure was made by a 7-layer co-extrusion, blown process with a diameter of 14 ft and a gauge of 6.5-9.5 mil. Multilayer film 1 comprises polystyrene (PS) in 3 layers. The percentages by weight of the components of multilayer film 1 are shown in Table 1. Total PS content of the film is 7%.

TABLE 1
Composition of multilayer film 1.

| Layer ratio | | | Wt. Percent of |
|---|---|---|---|
| (%) | Layer # | Material used | Layer (%) |
| 19 | 1 | High strength PE | 95 |
| | Inner | Black pigment | 5 |
| | Layer | | |
| 21 | 2 | High strength PE | 95 |
| | Fifth Core | Black pigment | 5 |
| | Layer | | |
| 8 | 3 | High strength PE | 68 |
| | Fourth | PS particles | 20 |
| | Core layer | UV inhibitor | 3 |
| | | White pigment | 9 |
| 4 | 4 | High density PE | 97 |
| | Third Core | UV inhibitor | 3 |
| | Layer | | |
| 8 | 5 | High strength PE | 68 |
| | Second | PS particles | 20 |
| | Core | UV inhibitor | 3 |
| | Layer | White pigment | 9 |
| 21 | 6 | High strength PE | 88 |
| | First Core | UV inhibitor | 3 |
| | Layer | White pigment | 9 |
| 19 | 7 | High strength PE | 74 |
| | Outer | PS particles | 20 |
| | Layer | UV inhibitor | 3 |
| | | Slip/Process aid | 3 |

### Example 1A

An exemplary storage bag formed from multilayer film 1A in accordance with certain aspects of the present disclosure was made by a 7-layer co-extrusion, blown process with a gauge of about 9 mil±about 20%. The percentages by weight of the components of multilayer film CA are shown in Table 2. Multilayer film A comprises polystyrene (PS) in 2 layers. Total PS content of the film is 2.8%. The properties of multilayer film A are shown in Table 3.

TABLE 2
Composition of multilayer film 1A.

| Layer ratio | | | Wt. Percent of |
|---|---|---|---|
| (%) | Layer # | Material used | Layer (%) |
| 19 | 1 | Polyethylene | 100 |
| | Inner | Slip Agent | |
| | Layer | Carbon Black | |
| 20 | 2 | Polyethylene | 93 |
| | Fifth | Titanium | |
| | Core | Dioxide | |
| | Layer | UV inhibitor | |
| | | Polystyrene | 7 |
| 8.5 | 3 | Polyethylene | 100 |
| | Fourth | Titanium | |
| | Core | Dioxide | |
| | layer | UV inhibitor | |
| 4 | 4 | Polyethylene | 100 |
| | Third Core | UV inhibitor | |
| | Layer | | |
| 8.5 | 5 | Polyethylene | 100 |
| | Second | Titanium | |
| | Core | Dioxide | |
| | Layer | UV inhibitor | |
| 20 | 6 | Polyethylene | 93 |
| | First | Titanium | |
| | Core | Dioxide | |
| | Layer | UV inhibitor | |
| | | Polystyrene | 7 |
| 20 | 7 | Polyethylene | 100 |
| | Outer | Slip Agent | |
| | Layer | Titanium | |
| | | Dioxide | |
| | | UV inhibitor | |

TABLE 3
Properties of multilayer film 1A.

| Property | Unit | Value |
|---|---|---|
| Gauge (avg. 5) | mil | 9.13 |
| Tensile Gauge MD (avg. 5) | mil | 9.13 |
| Stress @ Peak MD (avg. 5) | PSI | 4,777 |
| Strain @ Peak MD (a vg. 5) | % | 914 |
| Stress @ Break MD (avg. 5) | PSI | 4,777 |
| Strain @ Break MD (avg. 5) | % | 914 |
| Stress @ Yield MD (avg. 5) | PSI | 1,569 |
| Strain @ Yield MD (avg. 5) | % | 6 |
| Stress @ 5% Strain MD (avg_5) | PSI | 1,481 |
| Stress@ 10% Strain MD (avg. 5) | PSI | 1,784 |
| Stress @ 25% Strain MD (avg. 5) | PSI | 1,813 |
| Stress @ 50% Strain MD (avg. 5) | PSI | 1,772 |
| Stress @ 1 00% Strain MD (avg. 5) | PSI | 1,653 |
| Secant Modulus MD (1%) (avg. 5) | PSI | 41,526 |
| TEA MD (avg. 5) | in · lbf | 409 |
| Elmendorf Tear MD Arm | g | 6,400 |
| Elmendorf Tear MD (avg. 5) | gf | 4,214 |
| Tensile Gauge TD (avg. 5) | mil | 9.46 |
| Stress @ Peak TD (avg. 5) | PSI | 4,216 |
| Strain @ Peak TD (avg. 5) | % | 934 |
| Stress @ Break TD (avg. 5) | PSI | 4,216 |
| Strain @ Break TD (avg. 5) | % | 934 |
| Stress @ Yield TD (avg. 5) | PSI | 1,576 |
| Strain @ Yield TD (avg. 5) | % | 6 |
| Stress @ 5% Strain TD (avg. 5) | PSI | 1,477 |
| Stress @ 1 0% Strain TD (avg. 5) | PSI | 1,759 |
| Stress @ 25% Strain TD (avg. 5) | PSI | 1,624 |
| Stress @ 50% Strain TD (avg. 5) | PSI | 1,416 |
| Stress @ 100% Strain TD (avg. 5) | PSI | 1,448 |
| Secant Modulus TD (1%) (avg. 5) | PSI | 43,962 |
| TEA TD (avg. 5) | in · lbf | 377 |
| Elmendorf Tear TD Arm | g | 6,400 |
| Elmendorf Tear TD (avg. 5) | gf | >5120 |
| Dart Drop (26″) (avg. 10) | g | 1,560 |

### Example 2: TD Creep Resistance Test

An exemplary custom-designed creep-resistance test was developed to determine the creep-resistance of the storage bag formed from multilayer film 1A in accordance with certain aspects of the present disclosure. For comparison, a 1 cm wide sample was taken from both a comparative polyethylene-only bag that does not include polystyrene, and the storage bag formed from multilayer film 1A, both oriented in the TD (Transverse Direction). The test is done in a heated oven at 60° C. for 24 hours using a 1 kg weight on a 1 cm wide and 10 cm long film sample. The length of the film is measured at 0 hours and 24 hours twice to calculate the percent stretch (%) when the weight is on.

The comparative polyethylene-only bag exhibited significant stretching during the creep-resistance test, reaching up to 115% of its original length. In contrast, the bag formed from multilayer film 1A comprising the polystyrene demonstrated superior performance, with stretching consistently measuring less than 110% under the same test conditions.

1. A storage bag for storing agricultural products, the storage bag comprising
a polymeric tube formed to include a storage space therein and a fill aperture arranged to open into the storage space at a first end of the polymeric tube and
a first closure coupled to an opposite second end of the polymeric tube to close the opposite second end,
wherein the polymeric tube is formed from a multilayer film comprising an inner layer configured to define, at least in part, the storage space, an outer layer located in spaced-apart relation to the inner layer, and a core layer located between the inner and outer layers and at least one of the layers of the multi-layer film is configured to minimize circumferential creep in the polymeric tube during filling of the storage bag by agricultural products so that puncture and tearing of the storage bag is minimized.

2. The storage bag of claim 1, wherein the multilayer film comprises a polyethylene polymer and a polyethylene-incompatible polymer.

3. The storage bag of claim 2, wherein the polyethylene-incompatible polymer is at least one of polypropylene, polystyrene, ethylene-vinyl alcohol copolymer, nylon, or combinations thereof.

4. The storage bag of claim 3, wherein the polyethylene-incompatible polymer is polystyrene.

5. The storage bag of claim 2, wherein the multilayer film comprises less than about 10 wt % of the polyethylene-incompatible polymer.

6. The storage bag of claim 5, wherein the multilayer film comprises about 1.5 wt % to about 10 wt % of the polyethylene-incompatible polymer.

7. The storage bag of claim 2, wherein the multilayer film comprises greater than about 80 wt % of polyethylene.

8. The storage bag of claim 1, wherein the multilayer film comprises an additive.

9. The storage bag of claim 8, wherein the additive is at least one of a pigment, a UV inhibitor, a UV absorber, a slip aid, a process aid, or combinations thereof.

10. The storage bag of claim 1, wherein the core layer comprises a polyethylene polymer and a polyethylene-incompatible polymer.

11. The storage bag of claim 2, wherein the core layer comprises an at least one sublayer comprising the polyethylene polymer and the polyethylene-incompatible polymer.

12. The storage bag of claim 1, wherein the multilayer film has a thickness of about 6 mil to about 11 mil.

13. The storage bag of claim 1, wherein the polymeric tube has a diameter of about 6 feet to about 14 feet.

14. A multilayer film comprising
an inner layer comprising a polyethylene material,
an outer layer spaced apart from the inner layer and comprising a polyethylene material, and
a core layer arranged to extend between and interconnect the inner layer and the outer layer,
wherein at least one of the layers of the multilayer film is configured to minimize puncture of the multilayer film by objects extending through the multilayer film from the inner layer through the outer layer so that puncture and tearing of the multilayer film is minimized.

15. The multilayer film of claim 14, wherein the core layer comprises an at least one sublayer comprising a polyethylene polymer and a polyethylene-incompatible polymer.

16. The multilayer film of claim 15, wherein the polyethylene polymer is independently selected from a high strength polyethylene polymer or a high density polyethylene polymer.

17. The multilayer film of claim 16, wherein the polyethylene incompatible polymer comprises a polypropylene, a polypropylene fine particle composition, a polystyrene, a polystyrene fine particle composition, an ethylene vinyl alcohol copolymer, an ethylene vinyl alcohol copolymer fine particle composition, a nylon, a nylon fine particle composition, or any combination thereof.

18. The multilayer film of claim 14, wherein at least one of the inner layer and the core layer comprises an additive.

19. The multilayer film of claim 14, wherein the multilayer film has a stretch of less than or equal to 15% in a 24 hour high temperature creep-resistance test.

20. The multilayer film of claim 14, wherein the outer layer comprises PIR (post industrial recycled) resin, PCR (post consumer recycled) resin, or combinations thereof.
